(19) United States
(12) Patent Application Publication
(10) Pub. No.: US 2025/0302209 A1
(43) Pub. Date: Oct. 2, 2025

(54) ROTARY ASSET MANAGEMENT DEVICE

(71) Applicant: SIGNIFI SOLUTIONS INC., Mississauga (CA)

(72) Inventors: Madison Grace George Laymon, Toronto (CA); Richard Longo, Etobicoke (CA); Emil Jose Rodriguez Osorio, Etobicoke (CA); Yong Suk Jin, Oakville (CA); Shamira Jaffer, Mississauga (CA)

(21) Appl. No.: 19/085,717

(22) Filed: Mar. 20, 2025

Related U.S. Application Data
(60) Provisional application No. 63/571,230, filed on Mar. 28, 2024.

(51) Int. Cl. A47F 3/02; A47F 3/11; G05B 13/02

(52) U.S. Cl. CPC A47F 3/02; A47F 3/11; G05B 13/024

(57) ABSTRACT

An example asset management device includes: an enclosure; a carousel configured to rotate within the enclosure and comprising: a first number of radial partitions configured to divide the carousel into the first number of sectors; a second number of carousel shelves, each having the first number of sector shelves, wherein each sector shelf is configured to be mounted at a same height on the radial partitions to define the carousel shelf; an access structure of the enclosure, the access structure supporting the second number of access doors, each corresponding to one carousel shelf; and a controller interconnected with the carousel and the access structure, the controller configured to, in response to an access request: identify a target carousel shelf and a target sector of the access request; rotate the carousel to align the target sector with the access structure; and release the access door corresponding to the target carousel shelf.

### FIELD

The specification relates generally to asset management devices, and more particularly to rotary asset management devices.

### BACKGROUND

Asset management devices may be used in the retail sector to showcase and dispense items. However, asset management devices in the retail sector may be insecure or cumbersome to use and operate.

### SUMMARY

According to an aspect of the present specification an example asset management device includes: an enclosure; a carousel configured to rotate within the enclosure, the carousel comprising: a central column including a first number of radial partitions configured to divide the carousel into the first number of sectors; a second number of shelf sets defining the second number of carousel shelves, each shelf set having the first number of sector shelves, wherein each sector shelf in the shelf set is configured to be mounted at a same height on the radial partitions to define the carousel shelf; an access structure of the enclosure, the access structure supporting the second number of access doors, each access door corresponding to one carousel shelf; and a controller interconnected with the carousel and the access structure, the controller configured to, in response to an access request: identify a target carousel shelf and a target sector of the access request; rotate the carousel to align the target sector with the access structure; and release the access door corresponding to the target carousel shelf.

According to another aspect of the present specification, an example method of operating an asset management device includes: receiving an access request; identifying a target carousel shelf and a target sector of the access request; rotating a carousel of the asset management device to align the target sector with an access structure of the asset management device; and releasing an access door of the access structure, the access door corresponding to the target carousel shelf.

### BRIEF DESCRIPTION OF DRAWINGS

Implementations are described with reference to the following figures, in which:

FIG. 1 depicts an example rotary asset management device in accordance with the present disclosure.

FIGS. 2A and 2B depict an example carousel of the device of FIG. 1.

FIG. 3 depicts a sector shelf mounted on the carousel of the device of FIG. 1.

FIG. 4A depicts an example shelf mount for mounting a sector shelf on a carousel in the device of FIG. 1.

FIG. 4B depicts the shelf mount of FIG. 4A supporting sector shelves.

FIG. 5 depicts an example mounting aperture for the shelf mount of FIG. 4A.

FIG. 6 depicts a cross section of the asset management device of FIG. 1.

FIG. 7 depicts a block diagram of certain components of the device of FIG. 1.

FIG. 8 depicts a flowchart of an example method of operating a rotary asset management device.

FIG. 9 depicts another example rotary asset management device in accordance with the present disclosure.

### DETAILED DESCRIPTION

In the retail sector, it is advantageous to showcase products while keeping them protected from theft. Existing systems with rotary carousels for showcasing products are insecure due to not managing access to portions of the carousel or require separately controllable carousels to manage access. Further, systems are often circular to accommodate the carousels, which may be an inefficient use of space and requires specialized materials and framing.

As described herein, a rotary asset management device may provide access and display to retail products, while still serving as a loss-prevention solution. For example, the carousel may rotate substantially constantly to showcase all products. Further, the system provides a modular design to allow customized sizes of carousel shelves, enabling configuration modifications post-deployment. To limit access to the shelves, the rotary locker can include hinged doors at the front or other sides depending on user's requirements. The rotary locker system can include further features such as minimized frames, alignments of carousel-window, battery power availability and power saving mode.

To install and maintain the device efficiently, a butterfly-shaped shelf mount may remove the need for bolting shelves into place and facilitate easier assembly and interchangeability. The structure of the shelf mount may support two shelves simultaneously, with corresponding cutouts (slits) on the carousel spine. Furthermore, notch features may be incorporated to provide further shelf stability.

As described herein, the rotary asset management device enables and provides loss prevention solutions, by employing a combination of hinged doors, latches, and an anti-tamper structure. The device further provides showcase solutions by employing a combination of rotating shelves, lighting, windows, including small or thin bezels, and user interface design. The device further provides maintenance and intelligent control solutions with modular shelf mounting

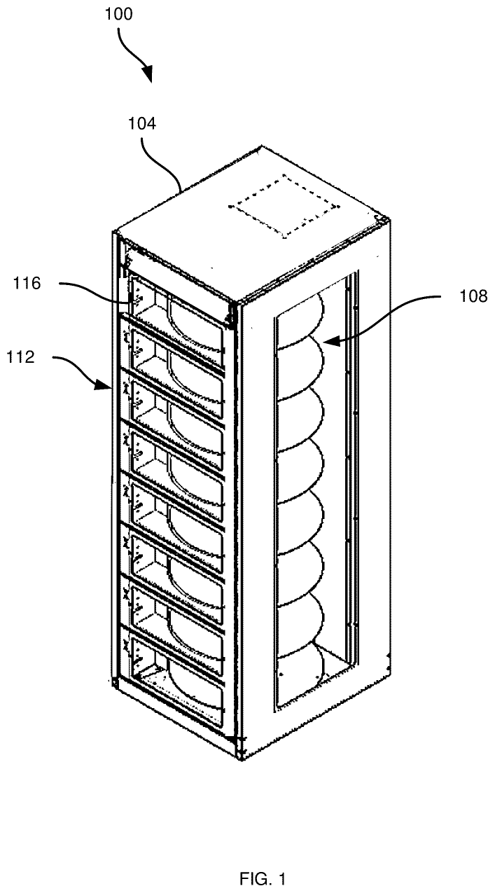

FIG. 1 depicts a rotary asset management device 100 in accordance with the present disclosure. The asset management device 100 (also referred to herein as simply the device 100) is generally configured to store assets or items which may be dispensed to users. For example, the device 100 may be a type of vending machine or the like to dispense items upon sale to the user, an organizational and/or storage cabinet, console, or the like, or similar. For example, the device 100 may be deployed in a facility such as a retail store, a hospital, a warehouse, an office building, or the like.

The device 100 includes an enclosure 104, a carousel 108 housed within the enclosure 104, and an access structure 112 having a plurality of doors 116 for providing access to the enclosure 104, and in particular, to items stored on the carousel 108.

The enclosure 104 is generally configured to house the internal components of the device 100 and secure the contents from unauthorized access. The enclosure 104 may include a frame, walls, plates, doors, and the like to define an interior of the device 100 in which the internal components are enclosed and to provide suitable access to the interior. For example, the enclosure 104 may include one or more lockable doors which may restrict access to the interior of the device 100 to authorized users. The enclosure 104 may also include, in some examples, wheels, motors, navigational units, batteries, and the like to support the operation and optional mobility of the device 100.

In some examples, access structure 112 may form part of the enclosure 104. For example, the access structure 112 may form one side (e.g., a front side) of the enclosure 104. A remainder of the enclosure 104 may preferably be substantially translucent to allow users to view the contents of the device 100. For example, the enclosure 104 may include a frame with a thin bezel to support glass panes forming walls of the enclosure 104. The access structure 112 may generally be configured to control and/or manage access to portions of the enclosure 104, and in particular to shelves therein. Accordingly, in some examples, the access structure 112 may be configured with horizontally disposed access shelves and vertically disposed blocking panels as will be further described below.

The carousel 108 is configured to rotate within the enclosure 104, about a substantially vertical rotational axis. The carousel 108 is generally configured to support items for vending, dispensing, or storage within the device 100. The carousel 108 may be configured to rotate within the enclosure 104 to allow display of the items thereon. In particular, the carousel 108 may therefore rotate about a substantially vertical rotational axis, and accordingly may have a substantially circular axial cross-section.

The carousel 108 may be connected to a belly pan and motor (not shown) which may preferably be oriented at a rear or underside of the carousel 108 so as not to obstruct the carousel 108. To rotate the carousel 108, a motor in a pulley system may be incorporated. In particular, the rotary and motor axes may be separated by pulleys to implement custom gear reduction. Accordingly, the motor may achieve sufficient torque and speed parameters as desired for rotation of the carousel 108. For example, the carousel 108 may be configured to rotate at 15 degrees per second.

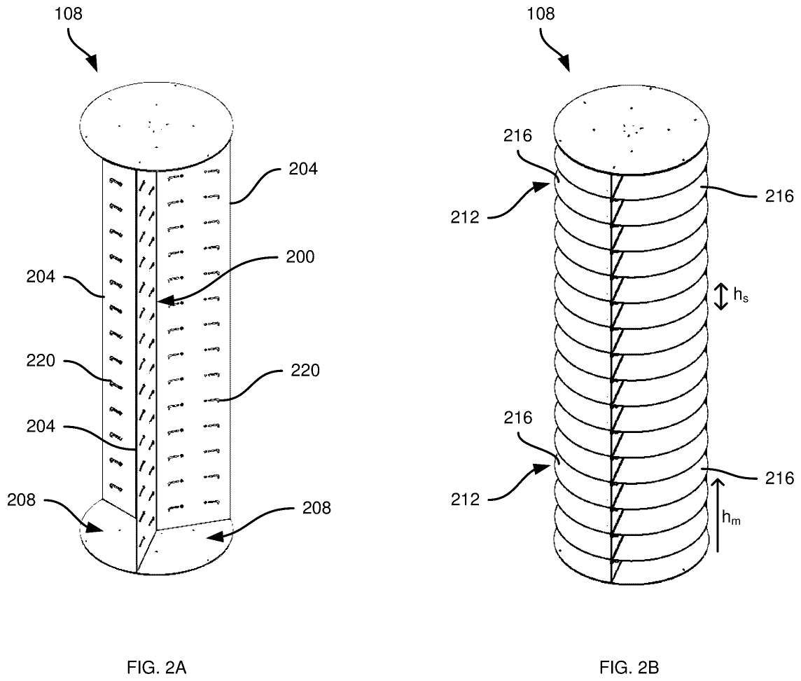

Referring to FIG. 2A, the carousel 108 is depicted in part. The carousel 108 includes a central column 200 having a plurality of radial partitions 204 extending from the central column 200 to divide or partition the carousel 108 into a number of sectors 208. Preferably, the radial partitions 204 may be equally spaced such that the sectors 208 are substantially equally sized. For example, the carousel 108 may preferably include three or four radial partitions 204 to partition the carousel 108 into three or four sectors 208, respectively. In such examples, the size of each of the sectors 208 may correspond closely with the size of one of the sides of the enclosure 104, and in particular the access structure 112. Thus, when the carousel 108 has three or four sectors 208, the accessibility of each sector and items stored in the carousel may be improved and optimized.

Referring to FIG. 2B, the carousel 108 is depicted with a plurality of carousel shelves 212. The carousel shelves 212 may provide a horizontal partition of the carousel 108 at particular heights along the height of the carousel 108. Each carousel shelf 212 may be formed by a set of sector shelves 216, according to the number of sectors 208 defined in the carousel 108. Thus, each sector shelf 216 may be sized according to the sectors 208. In particular, each sector shelf 216 in a given set is configured to be mounted on the radial partitions 204 at a same height to define the carousel shelf 212 which extends through each of the sectors 208.

Each of the carousel shelves 212 may be independently mounted on the radial partitions 204 such that each carousel shelf 212 may have a different shelf height hₛ (i.e., a space above the carousel shelf 212 in which to store items). For example, as can be seen in FIG. 2A, the radial partitions may include a plurality of mounting apertures 220 configured to receive shelf mounts for mounting the sector shelves 216. In particular, the mounting apertures 220 may be located at predefined intervals over the height of the carousel 108. That is, the location of the mounting apertures 220 may define the possible mounting heights hₘ (i.e., intervals along the height of the carousel 108 at which the sector shelves 216 may be mounted). In the example depicted in FIG. 2B, each of the mounting apertures 220 is in use to mount the sector shelves 216 and accordingly each of the resulting carousel shelves 212 may have an equal shelf height. In other examples, some of the sector shelves 216 at given mounting heights may be omitted, resulting in carousel shelves 212 having different shelf heights (e.g., a double height, triple height, etc. shelf height). In other examples, other mounting mechanisms other than the mounting apertures 220 may be provided to mount the carousel shelves 212.

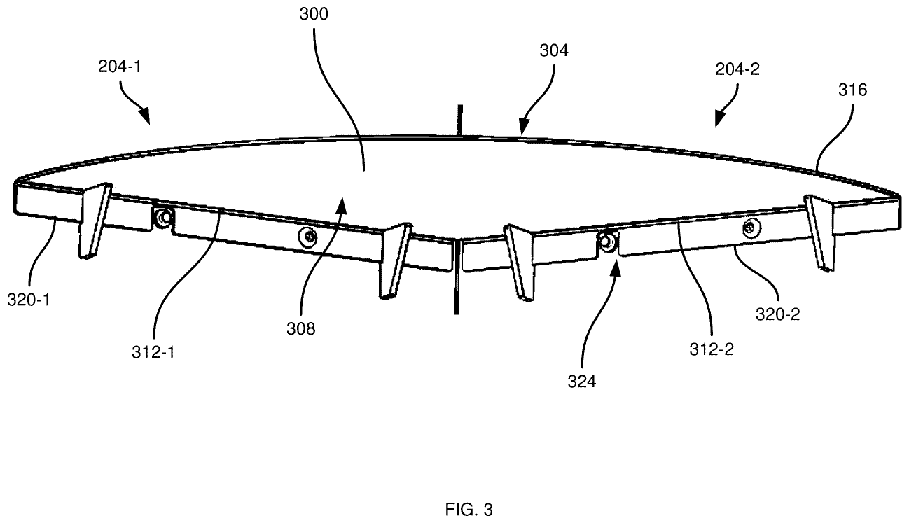

Referring to FIG. 3, a bottom perspective view of a sector shelf 216 mounted between two radial partitions 204-1 and 204-2 is depicted. The sector shelf 216 includes a support surface 300 having a top side 304 configured to bear items for display, vending or storage in the device 100 and an underside 308 opposite the top side 304. The support surface 300 is sector-shaped, and particularly, sized to fit within the sector 208 in which the sector shelf 216 is configured to be mounted. Accordingly, the support surface 300 has two radial edges 312-1 and 312-2 (referred to herein generically as a radial edge 312 and collectively as the radial edges 312; this nomenclature is also used elsewhere herein) configured to be aligned with the radial partitions 204-1 and 204-2, respectively, and a circumferential edge 316 spanning between the two radial edges 312.

As used herein, similar features of a given angular component or components having an angular orientation may be referred to as a “clockwise” or a “counterclockwise” feature. When viewed from a top view, traversal from the component or from a midpoint between the two features to the clockwise feature comprises a clockwise movement, while traversal from the component or from the midpoint between the two features to the counterclockwise feature comprises a counterclockwise movement. Thus, in the present example, the first radial edge 312-1 may also be referred to herein as the clockwise radial edge 312, while the second radial edge 312-2 may also be referred to herein as the counterclockwise radial edge 312.

The sector shelf 216 further includes a first flange 320-1 extending along the first radial edge 312-1 at the underside 308 of the support surface 300 and a second flange 320-2 extending along the second radial edge 312-2 at the underside 308 of the support surface 300. The flanges 320 are configured to facilitate mounting of the sector shelf 216 as will be described in further detail below.

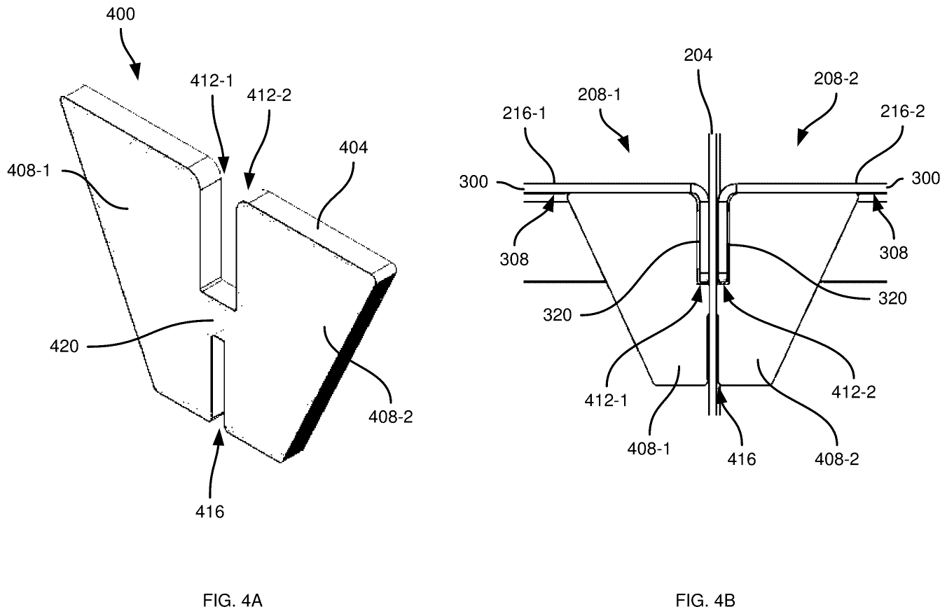

In particular, referring to FIG. 4A, the sector shelves 216 may be mounted to the radial partitions 204 using shelf mounts 400 received in the mounting apertures 220. To facilitate and ensure mounting of each sector shelf 216 at the same height as the other sector shelves 216 in the set, the device 100 may deploy shelf mounts 400 configured to mount the sector shelves 216 on either side of a radial partition 204.

The shelf mount 400 includes a plate 404 having a first wing 408-1 and a second wing 408-2 (referred to herein generically as a wing 408 and collectively as wings 408). In particular, to enable the dual-sided mounting capability, the first wing 408-1 is configured to extend on a first side of a radial partition 204 on which the shelf mount 400 is installed and the second wing 408-2 is configured to extend on a second side of the radial partition 204 on which the shelf mount 400 is installed. Thus, since the radial partitions 204 divide the carousel 108 into sectors 208, opposing sides of the radial partitions 204 are in different sectors 208, and hence the first wing 408-1 may be configured for supporting a first sector shelf 216 in a first sector 208 on the first side of the radial partition 204 while the second wing 408-2 is configured for supporting a second sector shelf 216 in a second sector 208 on the second side of the radial partition 204.

In particular, the first wing 408-1 may further include a first shelf slot 412-1 configured to support the first sector shelf 216. Similarly, the second wing 408-2 may further include a second shelf slot 412-2 configured to support the second sector shelf 216. In the present example, the first shelf slot 412-1 and the second shelf slot 412-2 may be merged to form a single merged slot. In other examples, the shelf slots 412 may be independently defined in the respective wings 408.

The shelf mount 400 further includes a support slot 416 defined in the plate 404 between the wings 408. The support slot 416 is configured to interface with the mounting aperture 220 as will be described further below, to support the shelf mount 400 in the mounting aperture 220. As presently illustrated, the combined slot 412 may be wider than the support slot 416 to allow the slots 412 to receive both the first sector shelf 216 and the second sector shelf 216 on either side of the radial partition 204, while the support slot 416 has a width complementary to the radial partition 204. The support slot 416 may terminate at a bridge 420 of the plate 404. The bridge 420 may therefore also be disposed between the wings 408 and may substantially join or connect the wings 408.

Referring to FIG. 4B, the shelf mount 400 is depicted mounted on a radial partition 204 and supporting a first sector shelf 216-1 (i.e., on a clockwise side of the radial partition 204) and a second sector shelf 216-2 (i.e., on a counterclockwise side of the radial partition 204). In particular, the support slot 416 is configured to receive the radial partition 204 to allow the first wing 408-1 to extend on a first side (i.e., the clockwise side) of the radial partition 204 into a first sector 208-1 and the second wing 408-2 to extend on a second side (i.e., the counterclockwise side) of the radial partition 204 into a second sector 208-2.

To mount the first sector shelf 216-1 on the radial partition, the counterclockwise flange 320 of the first sector shelf 216-1 is configured to be received in the first shelf slot 412-1 of the shelf mount 400, until the first wing 408-1 contacts the underside 308 of the support surface 300 to support the first sector shelf 216-1. Similarly, to mount the second sector shelf 216-2 on the radial partition 204, the clockwise flange 320 of the second sector shelf 216-2 is configured to be received in the second shelf slot 412-2 of the shelf mount 400, until the second wing 408-2 contacts the underside 308 of the support surface 300 to support the second sector shelf 216-2.

Thus, the shelf mount 400 is configured to straddle the radial partition 204 to support sector shelves 216 on either side of the radial partition 204.

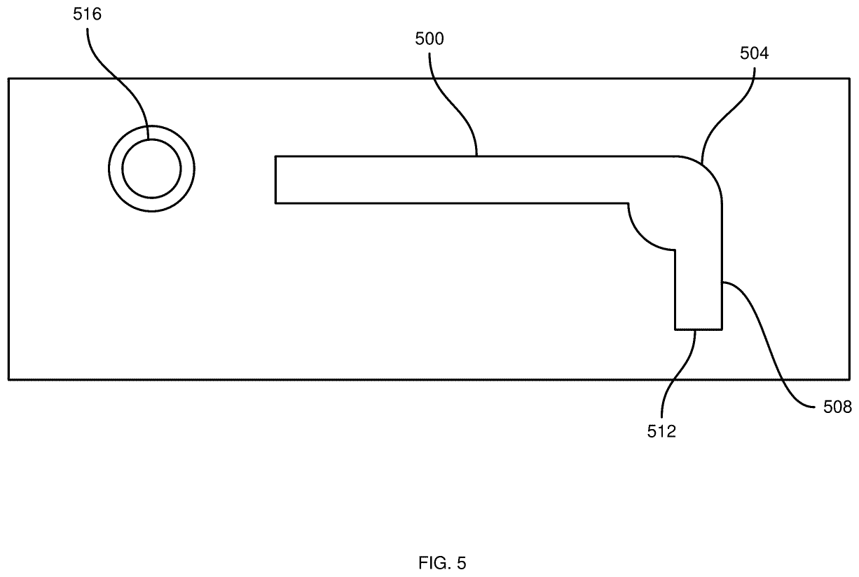

Turning now to FIG. 5, a closer view of a mounting aperture 220 on one of the radial partitions 204 is depicted.

The mounting aperture 220 includes a reception slit 500, a bend 504 at an end of the reception slit 500 and a support slit 508 extending from the bend 504 perpendicular to the reception slit 500, terminating at an end 512.

In operation, the support slit 508 is configured to interface with the support slot 416 of the shelf mount 400 to fix the shelf mount 400 in place in the mounting aperture 220. In particular, the bridge 420 of the shelf mount 400 may sit on the end 512, such that the support slot 416 extends past the end 512 with the radial partition 204 received in the support slot 416. Preferably, the support slit 508 may be substantially shorter than the height of the shelf mount 400 for increased stability when the shelf mount 400 is in the mounted position with the support slot 416 interfacing with the support slit 508.

Accordingly, the reception slit 500 is generally configured to receive the shelf mount 400. In particular, the plate 404 may be substantially planar to allow the shelf mount 400 to be inserted into the reception slit 500. Accordingly, the height of the reception slit 500 may correspond to a depth of the plate 404. To allow for the subsequent movement of the shelf mount 400 to the mounted position, the plate 404 may be inserted into the reception slit 500 with the support slot 416 oriented towards the bend 504. Accordingly, the reception slit 500 may have a length L corresponding to at least a height of the plate 404.

To secure the shelf mount 400 in the mounted position, after inserting plate 404 into the reception slit 500 such that the bridge 420 is in the reception slit 500 with the support slot 416 oriented towards the bend 504, the plate 404 may be moved along the reception slit 500 towards the bend 504 until the bridge 420 is in the bend 504. The bend 504 may have a larger space to allow the plate 404 to be rotated with the bridge 420 in the bend 504 until the support slot 416 is aligned with the support slit 508. The plate 404 may then be moved along the support slit 508 until the bridge 420 contacts the end 512 and the shelf mount 400 is in the mounted position.

In some examples, the mounting aperture 220 may additionally include a secondary aperture 516. The secondary aperture 516 may be configured to receive a bolt to further secure the sector shelf 216 to the radial partition 204.

Returning to FIG. 3, each sector shelf 216 may be mounted to the radial partitions 204 by one or more shelf mounts 400 per flange 320. In the present example, two shelf mounts 400 are employed. For example, one of the shelf mounts 400 may be located closer to the central column 200, while another shelf mount 400 may be located closer to the circumferential edge 316. The shelf mounts 400 facilitate the mounting of the sector shelves 216 to the radial partitions 204.

In some examples, the flanges 320 may include apertures and corresponding notches 324 to accommodate nut and bolt fixtures to secure the sector shelf 216 to the radial partitions 204 in addition to the shelf mounts 400. In such examples, the clockwise flange 320-1 and the counterclockwise flange 320-2 may have complementary apertures and notches, since the counterclockwise flange 320-2 of one sector shelf 216 will be secured to a same radial partition 204 as the clockwise flange 320-1 of another sector shelf 216. Thus, the aperture in which a bolt is inserted in the counterclockwise flange 320-2 may correspond in location to the notch 324 of the clockwise flange 320-1 to allow a corresponding nut to be accommodated in the notch 324.

In still further examples, other means of mounting and/or securing the sector shelves 216 to the radial partitions 204, in particular to ensure the sector shelves 216 in a given set are mounted at the same mounting height hₘ to form a carousel shelf 212.

Returning to FIG. 1, since the carousel 108 may include configurable carousel shelves 212 with variable shelf heights hₛ, the access structure 112 may similarly be modular and configurable, to support the access doors 116 having variable heights corresponding to the carousel shelf 212 shelf height. That is, each of the access doors 116 may align with one carousel shelf 212.

Further, to ensure secure access to the items stored on the carousel shelves 212, each of the access doors 116 may be secured with independently controllable locking mechanisms, such as suitable mechanical, optomechanical, magnetic, electromagnetic, or other suitable locking mechanisms. For example, the locking mechanism may include a strike and latch, a bolt, combinations of the above, and the like. In some examples, the locking mechanism may additionally include anti-tamper features such as optical sensors or the like to confirm valid accesses to the interior of the device 100.

To further promote secure access to the items, in some examples the access structure 112 may include further partitioning features.

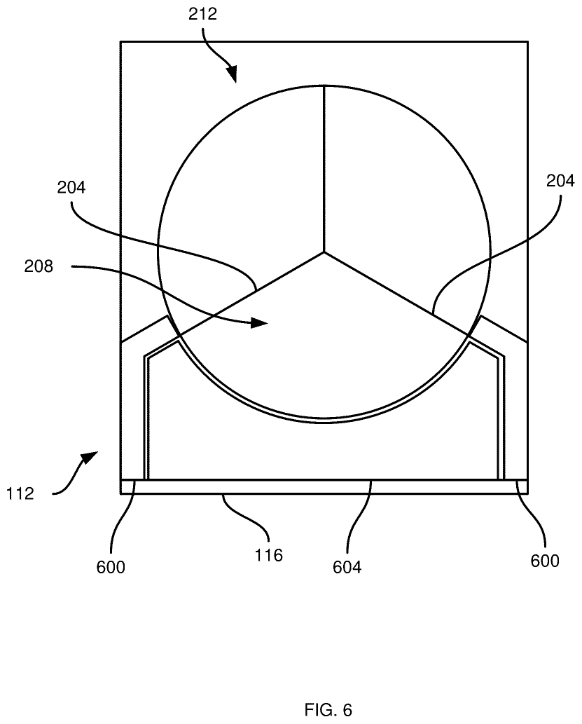

For example, referring to FIG. 6, a cross-section of one carousel shelf 212 and the access structure 112 is depicted.

The access structure 112 may include blocking panels 600 configured to align with the radial partitions 204 of the carousel 108 when one of the sectors 208 is aligned with the access structure 112. The access structure 112 may further include access shelves 604, aligned with each carousel shelf 212. The access shelves 604 may extend between the blocking panels 600, the access door 116 and the carousel shelf 212 to act as an extension of the carousel shelf 212 to facilitate access to the carousel shelf 212, and in particular the sector 208 of the carousel shelf 212 available via the access door 116 (i.e., to the sector shelf 216. The access shelves 604 may further serve to restrict access to other carousel shelves 212, to catch items and/or restrict items from falling, to prevent user's hands from getting caught in the carousel 108, and the like.

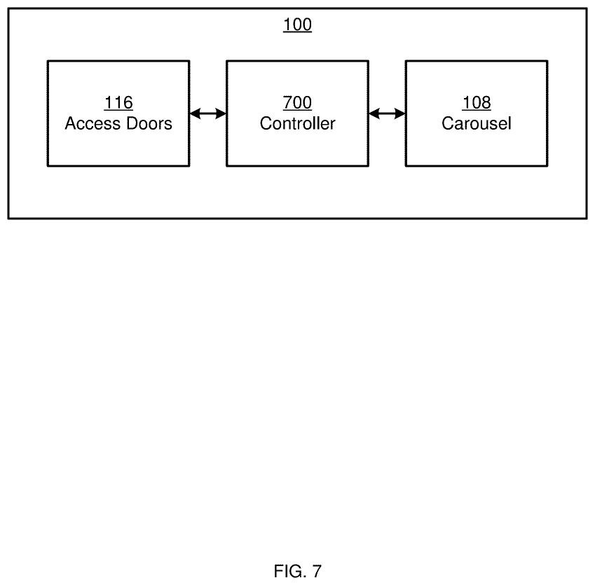

Turning now to FIG. 7, certain internal components of the device 100 are depicted. The device 100 includes a controller 700 interconnected with the components of the device 100, and in particular, with the carousel 108 and the access structure 112, and more particularly, each of the access doors 116.

The controller 700 may include a processor, a central processing unit (CPU), a microcontroller, a microprocessor, a processing core, a field-programmable gate array (FPGA), or similar. The controller 700 may include multiple cooperating processors. The controller 700 may cooperate with a memory, including a combination of volatile (e.g., random access memory or RAM) and non-volatile memory (e.g., read-only memory or ROM, electrically erasable programmable read-only memory or EEPROM, flash memory) to realize the functionality described herein. All or some of the memory may be integrated with the controller 700.

The memory may store applications, each including a plurality of computer-readable instructions executable by the controller 700; execution of the instructions configures the device 100 and/or the controller 700 to perform the actions discussed herein. The application may be implemented as a suite of distinct applications, and some or all of the functionality of the application may be implemented as dedicated hardware components, such as one or more FPGAs or application-specific integrated circuits (ASICs).

Generally, the controller 700 is configured to manage access to the device 100, as will be described further herein. For example, the device 100 may include one or more lighting fixtures controlled by the controller 700. For example, the controller 700 may control an activation time of the lighting fixtures to showcase items in the device 100. Further, the controller 700 may compute the rotational speed of the carousel 108 and user viewing angles and control the lighting fixtures to appropriately showcase and light up target items.

In some examples, the device 100 further may further include a communications interface (not shown) configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the device 100 to communicate with other computing devices. The specific components of the communications interface are selected based on the types of communication links that the device 100 communicates over.

The device 100 may further include one or more data capture devices (not shown) configured to capture data representing an internal space of the device 100, for example, to monitor and inform the operation of the device 100. A subset of the data capture devices may also be configured to capture data representing an exterior of the device 100, for example to capture data representing the environment of the device 100, users operating the device 100, nearby users, or the like. The data capture devices may include image and/or optical sensors configured to capture image data, video cameras or the like to capture video data, microphones to capture audio data, and the like. Other data capture devices may also be employed. The data capture data devices may be interconnected with the controller 700 to allow the controller 700 to manage or adjust the operational parameters of the device 100 based on the detected nearby user.

The device 100 may further include one or more user interface devices (not shown). The user interface devices may include a display, a touch screen, a payment device, an identification device, a keypad, a camera, combinations of the above, and the like. For example, the user interface may include both input and output devices, including lights or lighting fixtures or speakers or the like to provide feedback to the user. Additionally, the user interface may include non-contact assistive devices, including one or more cameras, speakers, microphones, and the like for gesture or voice recognition. For example, the controller may be configured to operate the at least one user interface device based on the detected nearby user.

In some examples, the device 100 may be enabled to function as a conversational agent to assist users in selecting items. For example, the device 100 may be configured to access a remote database to retrieve relevant information based on the user's conversations. Additionally, the device 100 may analyze users' appearances and characteristics based on image data captured by one or more cameras, image sensors, optical sensors, or the like, and application of computer vision and/or other suitable image analysis algorithms. Based on this analysis, the device 100 can infer users' preferences and likes and adjust the operation parameters of the device 100 such as carousel speed or lighting color.

In some examples, the device 100 may be enabled with multiple operational modes. For example, in a rotational mode, the carousel 108 may be configured to rotate continuously and to showcase items dynamically. In the rotational mode, the carousel 108 may be stopped when an access request is received, for example as described below. The rotational speed of the carousel 108 may be controlled and tracked by the controller 700 and/or may be verified using a position encoder. In a stationary mode, the carousel 108 may be configured to be stationary by default and may initiate rotation of the carousel 108 when an access request is received.

Additionally, the device 100 may have various user-interaction modes.

For example, in a showcase mode, the controller 700 may be in communication with the data capture devices to detect nearby users. When a user is detected within a threshold distance (e.g., 1 meter) from the device 100, the controller 700 the rotation of the carousel 108 may be slowed and/or stopped. Further, in some examples, the controller 700 may control one or more of the lighting fixtures of the device 100 to light up, dim, change color, or the like, according to a target item or section to highlight or showcase. For example, the target item or section to highlight may be determined by the controller 700 based on an analysis of a nearby user to detect a particular focus of a nearby user or the like. That is, the controller 700 may apply analysis, including, in some examples, an artificial intelligence or machine learning based analysis, together with real-time positioning information of the carousel to identify a specific item or section that a user is looking at. Further, the controller 700 may control an output device such as a display screen to display information about the identified item. In some examples if the user is not determined to be looking at a specific item, the controller 700 may control the display screen to display advertisements or the like.

In some examples, the device 100 may transition to a following mode from the showcase mode. In the following mode, the device 100 may select a single user's attention to follow, including for example, employing cameras and/or other data capture devices and AI to adjust the speed and rotation of the carousel to allow better viewing of the item by the user, including following the user's movement, activating or deactivating lighting fixtures to highlight the followed item, or the like. The controller 700 may further be configured to identify a user's gestures and/or voice and communicate with the user, for example by responding to user requests (e.g., via voice commands and/or via predetermined gestures, etc.) or the like.

In a stocking mode, the controller 700 may automatically rotate and/or position the carousel according to a desired target sector and shelf to be restocked. Preferably, the controller 700 may require the access doors 116 to be closed during rotation of the carousel for safety, such as to prevent a restocker's hands from being caught in the rotation of the carousel 108. In other examples, in the stocking mode, the enclosure 104 may be open (e.g., by releasing all the access doors 116 or an entirety of the access structure 112, etc.) while still enabling rotation of the carousel 108, for example by the controller 700 or by manual rotation by the user to restock the device 100.

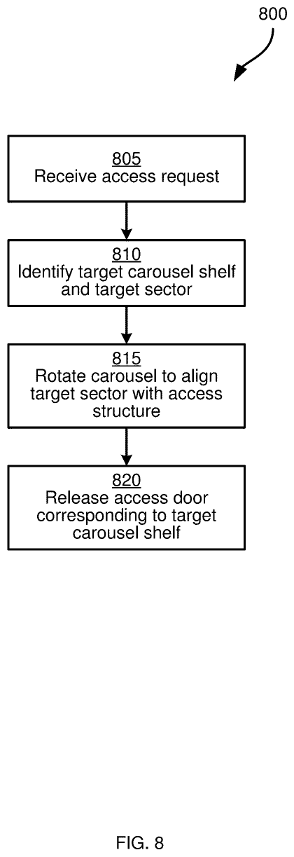

Turning now to FIG. 8, the functionality implemented by the device 100 will be discussed in greater detail, in particular, in an access mode of the device 100. FIG. 8 illustrates a method 800 of managing assets in an asset management device. The method 800 will be discussed in conjunction with its performance by the device 100, in particular via execution of instructions by the controller 700. The method 800 will be described with reference to components of FIGS. 1 to 7. In other examples, the method 800 may be performed by other suitable devices or systems.

At block 805, the device 100 receives an access request, for example via a user interface of the device 100. The access request may be, for example, a sales request (e.g., for a user to purchase an item stored the device 100), a restocking request, or the like. In response to the access request, the device 100 may perform one or more verification or authentication processes. For example, in response to a sales request, the device 100 may initiate a payment process and verify that payment has been successfully completed. In response to a restocking request, the device 100 may verify credentials of the user to confirm that the user is an authorized operator.

At block 810, in response to the access request, the device 100 identifies a target carousel shelf and a target sector for the access request. In particular, the access request may be to access and/or restock an item stored on the target carousel shelf and in particular, in the target sector of the target carousel shelf. In some examples, if more than one identical item is stored on multiple carousel shelves 212 and/or in multiple sectors 208, the device 100 may select a specific target carousel shelf and sector. For example, the device 100 may select the target carousel shelf and sector at random, or according to a set of predefined prioritization rules. For example, the prioritization rules may prioritize sale of items near a bottom of the carousel 108 to allow items at eye level to continue to be promptly displayed to encourage further purchases.

At block 815, the device 100 is configured to rotate the carousel 108 to align the target sector with the access structure 112. For example, if the device 100 is operating in the rotational mode, the device 100 may continue the regular rotation of the carousel 108 until the target sector is aligned with the access structure 112 and then may stop the rotation of the carousel 108. In other examples, the device 100 may stop the regular rotation of the carousel 108 and compute the shortest rotational distance of the target sector with the access structure 112 and rotate the carousel 108 in accordance with the shortest rotational distance. That is, the carousel 108 may rotate in either the same direction or an opposite direction of the regular rotational motion to align the target sector with the access structure 112. If the device 100 is operating in the stationary mode, the device 100 may initiate rotation of the carousel 108 until the target sector is aligned with the access structure 112.

For example, when the access structure 112 includes the blocking panels 600, the controller 700 may rotate the carousel 108 to align the radial partitions 204 with the blocking panels 600. In some examples, the controller 700 may control the carousel 108 according to a predefined and tracked relationship of the carousel 108 and rotation of the motor. In other examples, the device 100 may include one or more sensors (e.g., optical sensors or the like) in communication with the controller 700 to determine the orientation of the carousel 108 for alignment of the target sector with the access structure 112.

At block 820, the device 100 is configured to release the access door 116 corresponding to the target carousel shelf. Thus, since the target sector is aligned with the access structure 112, release of the access door 116 provides access to the target sector of the target carousel shelf, as identified from the access request.

In some examples, release of the access door 116 may simply include releasing a locking mechanism for the access door 116, for example to allow a user to manually open the access door 116. In other examples, the access door 116 may be controllable by the controller 700, and hence release of the access door 116 may include controlling the access door 116 to open.

In some examples, release of the access door 116 may additionally activate a brake system configured to limit a rotational motion of the carousel 108. That is, the brake system may prevent the carousel 108 from being rotated by applying external force. In other examples, the brake system may be activated in response to alignment of the target sector with the access structure, prior to releasing the access door 116.

In response to releasing the access door 116, the device 100 may issue a notification, such as a visual and/or auditory notification or the like. For example, the device 100 may include an LED light module which may blink or otherwise change color when access is granted. In some examples, the device 100 may additionally optionally determine whether the item has been retrieved. For example, the device 100 may detect whether the access door 116 was returned to the closed position after a predefined timeout period. After the predetermined timeout period, the device 100 may issue a reminder notification, such as a visual and/or auditory notification or the like and may additionally issue an error notification such as an email, text message, or the like to a managing operator of the device 100. In other examples, when the access door 116 is controllable, the device 100 may simply close the access door 116 after the predefined timeout period. In some examples, after the access door 116 is closed, the device 100 may re-initiate rotation of the carousel 108 in the rotational mode.

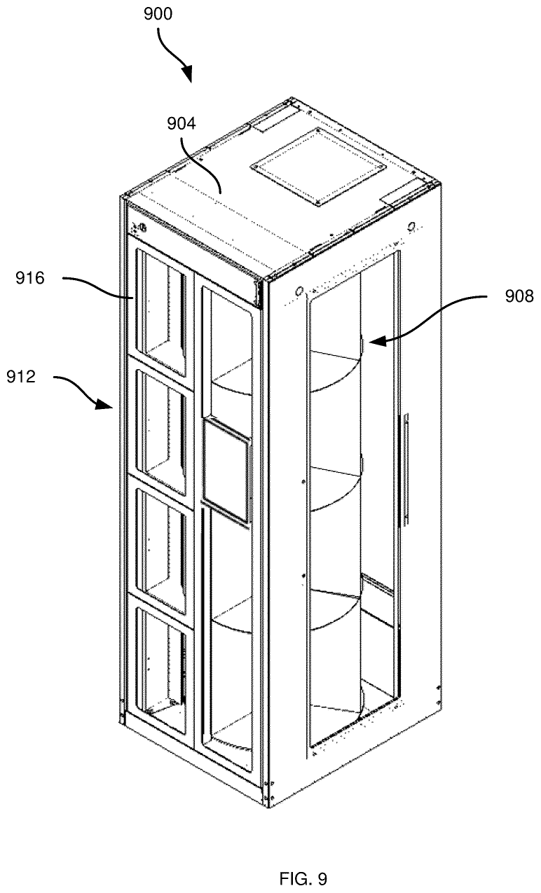

In other examples, other modifications may be applied to the asset management device as described herein. For example, the device may include multiple access structures for ease of use. Alternately, the device may include different types of access structures, such as dual door access structure, a narrow door access structure, or the like. Referring to FIG. 9, another example device 900 is depicted. The device 900 includes an enclosure 904, a carousel 908 housed within the enclosure 904, and an access structure 912 having a plurality of doors 916 for providing access to the enclosure 904, and in particular, to items stored on the carousel 908. In the example device 900, the access structure 912 may be configured to support doors 916 which are half the width of the access structure 912. In such examples, the radial partitions, the blocking panels, and the access shelves may be configured to align with and appropriately limit the portion of the enclosure 904 accessible by the doors 916 for suitable security. In other examples, other configurations are also contemplated.

Further, the system may include sensors and/or cameras to detect users approaching the system to rotate the carousel for optimal viewing, including performing image analysis and predicting a target sector to display to the approaching viewer according to predicted item preferences. In other examples, the enclosure may include transparent displays with touch functionality or augmented reality functionality.

The scope of the claims should not be limited by the embodiments set forth in the above examples but should be given the broadest interpretation consistent with the description as a whole.

1. An asset management device comprising:
an enclosure;
a carousel configured to rotate within the enclosure, the carousel comprising:
a central column including a first number of radial partitions configured to divide the carousel into the first number of sectors;
a second number of shelf sets defining the second number of carousel shelves, each shelf set having the first number of sector shelves, wherein each sector shelf in the shelf set is configured to be mounted at a same height on the radial partitions to define the carousel shelf;
an access structure of the enclosure, the access structure supporting the second number of access doors, each access door corresponding to one carousel shelf; and
a controller interconnected with the carousel and the access structure, the controller configured to, in response to an access request:
identify a target carousel shelf and a target sector of the access request;
rotate the carousel to align the target sector with the access structure; and
release the access door corresponding to the target carousel shelf.

2. The asset management device of claim 1, wherein the access structure includes blocking panels configured to align with the radial partitions defining the target sector when the target sector is aligned with the access structure.

3. The asset management device of claim 1, wherein the access structure includes blocking panels configured to align with the radial partitions defining the target sector when the target sector is aligned with the access door of the access structure.

4. The asset management device of claim 1, wherein the access structure further includes the second number of access shelves, each access shelf aligned with one of the carousel shelves.

5. The asset management device of claim 1, wherein the radial partitions comprise mounting apertures configured to receive shelf mounts for mounting the sector shelves.

6. The asset management device of claim 5, wherein each shelf mount comprises:
a plate having a first wing configured to extend on a first side of one of the radial partitions and a second wing configured to extend on a second side of the one of the radial partitions;
a support slot defined in the plate between the first wing and the second wing, the support slot configured to mate with a corresponding support slit of one of the mounting apertures to support the shelf mount in the one of the mounting apertures;
a first shelf slot in the first wing, the first shelf slot configured to support a first sector shelf on the first side of the one of the radial partitions; and
a second shelf slot in the second wing, the second shelf slot configured to support a second sector shelf on the second side of the one of the radial partitions.

7. The asset management device of claim 6, wherein the first shelf slot and the second shelf slot are integrally formed.

8. The asset management device of claim 1, further comprising a brake system configured to limit a rotational motion of the carousel when the target sector is aligned with the access structure.

9. The asset management device of claim 1, further comprising at least one data capture device configured to capture data representing a detected nearby user; and
wherein the controller is configured to adjust operational parameters of the device based on the detected nearby user.

10. The asset management device of claim 9, further comprising at least one user interface device; and
wherein the controller is configured to operate the at least one user interface device based on the detected nearby user.

11. A method of operating an asset management device, the method comprising:
receiving an access request;
identifying a target carousel shelf and a target sector of the access request;
rotating a carousel of the asset management device to align the target sector with an access structure of the asset management device; and
releasing an access door of the access structure, the access door corresponding to the target carousel shelf.

12. The method of claim 11, wherein aligning the target sector with the access structure comprises:
aligning radial partitions defining the target sector with blocking panels of the access structure.

13. The method of claim 11, further comprising:
prior to receiving the access request, rotating the carousel in a showcase mode; and
re-initiating rotating the carousel in the showcase mode when the access door is closed.

14. The method of claim 11, further comprising:
activating a brake system to limit a rotational motion of the carousel when the target sector is aligned with the access structure.

15. The method of claim 14, wherein activating the brake system is in response to releasing the access door.

16. The method of claim 14, wherein activating the brake system occurs prior to releasing the access door.

17. The method of claim 11, wherein rotating the carousel to align the target sector with the access structure comprises:
computing a shortest rotational distance of the target sector to the access structure; and
rotating the carousel in accordance with the shortest rotational distance.

18. The method of claim 11, further comprising:
obtaining data representing a detected nearby user; and
adjusting operational parameters of the device based on the detected nearby user.

19. The method of claim 18, further comprising:
operating at least one user interface of the device based on the detected nearby user.

20. The method of claim 19, further comprising:
detecting a focus of the detected nearby user; and
operating the at least one user interface based on the focus of the detected nearby user.
